(19) United States
(12) Patent Application Publication
(10) Pub. No.: US 2007/0269032 A1
(43) Pub. Date: Nov. 22, 2007

(54) Information processing apparatus and connection control method

(75) Inventors: Tadayuki Ohno, Tokyo (JP); Hiroshi Kurihara, Tokyo (JP); Tomoki Murakami, Tokyo (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC CORPORATION, Tokyo (JP)

(21) Appl. No.: 11/798,861

(22) Filed: May 17, 2007

(30) Foreign Application Priority Data
May 18, 2006 (JP) 2006-138621

(51) Int. Cl. H04M 3/42

(52) U.S. Cl. 379/201.01

(57) ABSTRACT

In an information processing apparatus, a connection control method performs a connection control of communication terminals through a network. A call is received from a calling one of communication terminals. The reception of the call is notified to a setting unit which sets the connection control data. The connection control of the communication terminals is performed in response to an instruction from the setting unit. A control is performed to provide a content data for the calling communication terminal before completion of the connection control.

### BACKGROUND ART

1. Field of the Invention

The present invention relates to an information processing apparatus, and more particularly relates to an information processing apparatus for controlling a connection state of a communication terminal.

2. Description of Related Art

In association with the improvement of the Internet technique and the popularization of a mobile phone, an IP (Internet Protocol) telephone and the like in recent years, a communication service has been diversified and enriched. For example, a service is attained in which music such as a hold tone is sent from a different apparatus to a telephone terminal through an SIP (Session Initiation Protocol) server that carries out a call control by using the SIP protocol. Also, a service is attained in which the destination of a telephone call is changed to a different telephone terminal that is not the call destination, or a communication among three parties can be made possible by connecting the 3 or more telephone terminals.

Japanese Laid Open Patent Application (JP-P2006-74133A) discloses a system in which a service of providing a melody, instead of a call tone (ring back tone) for indicating the state of calling to a telephone terminal, is used in a communication carrier. In this system, a music or message data preliminarily specified by a receiving side user is registered in a different apparatus (a ring back tone management apparatus, a ring back tone management table database) other than an apparatus for carrying out a connection control. At the time of the dialing to the receiving side user, the database is retrieved, and the corresponding music or message data is sent to a calling side terminal until the start of the communication.

However, in the system disclosed in Japanese Laid Open Patent Application (JP-P2006-74133A), the different apparatus that is not the apparatus for carrying out the connection control is required to retrieve the melody pre-registered by the receiving side user at the time of the dialing. Thus, the retrieving process brings about a longer wait time at a transmitting side terminal on account of the period between the actual start of the calling to the receiving side terminal and the providing of the ring back melody. In short, the tone of [Pu Pu Pu] instead of the familiar ring back tone of [Pururu, Pururu] indicative of the calling operation is provided for the transmitting side terminal, or a silent state is brought about, which casts a mental burden on the transmitting side user.

As mentioned above, in association with the diversification of the communication services in the recent years, there is a case that the apparatus side, which receives the call and carries out the connection control, performs complex processes based on the respective communication services. At the same time, there is also a necessity to search for the optional communication service to be provided based on the user. Thus, the process is expanded to attain the communication service to be performed after the reception of the call, which results increase of the wait time more and more, which gives rise to the non-answered state at the telephone terminal of the user on the calling side.

### SUMMARY

It is therefore an exemplary object of the present invention to make the quality of the communication services to be provided higher, and to use a wait time at the time of the calling effectively.

In an exemplary aspect of the present invention, a method of performing a connection control on communication terminals through a network, is achieved by receiving a call from a calling communication terminal; by notifying the call to an application server which sets a connection control data based on a content of the call; by performing the connection control between the communication terminals in response to an instruction from the application server after the notice; and by controlling a content server to provide a content data for the calling communication terminal before the connection control is completed.

In another exemplary aspect of the present invention, an information processing apparatus for performing a connection control between communication terminals through a network, includes a receiving section for receiving a call from a calling communication terminal; a notifying section for notifying reception of the call to an application server which sets a connection control data; a control section for controlling a content server to provide a content data for the calling communication terminal before a connection control between the communication terminals is completed; and a connecting section for performing the connection control in response to an instruction from the application server.

In still another exemplary aspect of the present invention, a computer-readable software product for realizing a method of performing a connection control on communication terminals through a network is provided. The method is achieved by receiving a call from a calling one of communication terminals; by notifying the reception of the call to an application server such that a connection control data is set; by controlling a content server to provide a content data for the calling communication terminal before the connection control is completed; and by performing the connection control between the communication terminals in response to an instruction from the application server after the notice.

### BRIEF DESCRIPTION OF THE DRAWINGS

The above and other objects, advantages and features of the present invention will be more apparent from the following description of certain preferred embodiments taken in conjunction with the accompanying drawings, in which:

FIG. 1 is a block diagram showing a configuration of a an entire network in a first embodiment;

FIG. 2 is a function block diagram showing a configuration of a connection control server in the first embodiment;

FIG. 3 is an explanation view showing operations of the entire system in the first embodiment;

FIG. 4 is a sequence view showing the operations of the entire system in the first embodiment;

FIG. 5 is an explanation view showing operations in an entire system in a second embodiment;

FIG. 6 is a sequence view showing the operations of the entire system in the second embodiment;

FIG. 7 is a flowchart showing operations of a media server in a third embodiment;

FIG. 8 is a function block diagram showing a configuration of a connection control server in a fourth embodiment; and

FIG. 9 is a flowchart showing operations of the connection control server in the fourth embodiment.

### EXEMPLARY EMBODIMENTS

The present invention has a feature in which an information processing apparatus, which receives a call from a communication terminal and carries out a connection control, provides a predetermined content data to the communication terminal immediately after the reception of call such that a calling user can view and listen to the content data, while a process for the connection control is carried out.

Hereinafter, in the exemplary embodiments, the specific configurations and operations will be described by taking a system that uses the SIP protocol to carry out the connection control between telephone terminals as an example. However, the present invention can be applied to a system that uses a protocol other than the SIP protocol and carries out the connection control of the communication terminals. Also, hereinafter, as a communication terminal, an IP telephone is exemplified. However, it may be a different communication terminal such as a mobile phone whose connection can be controlled in accordance with a predetermined protocol.

### First Exemplary Embodiment

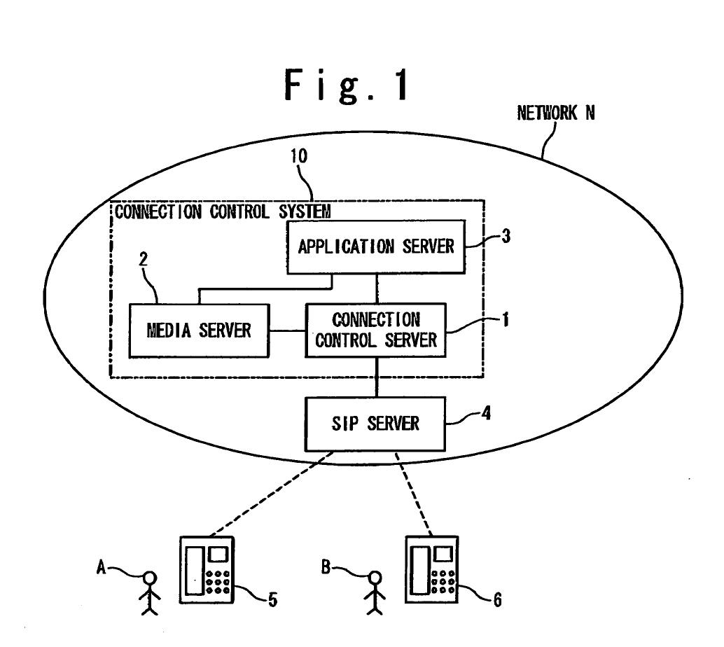

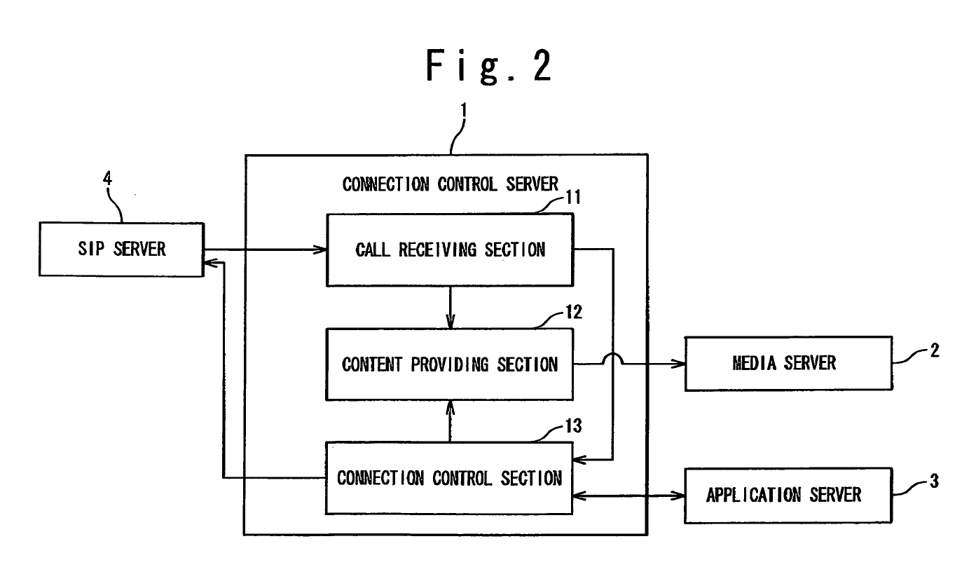

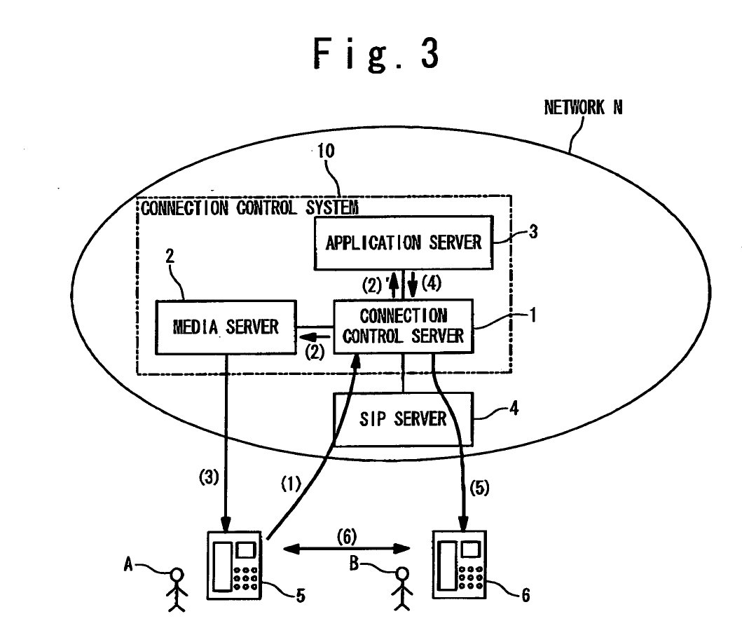

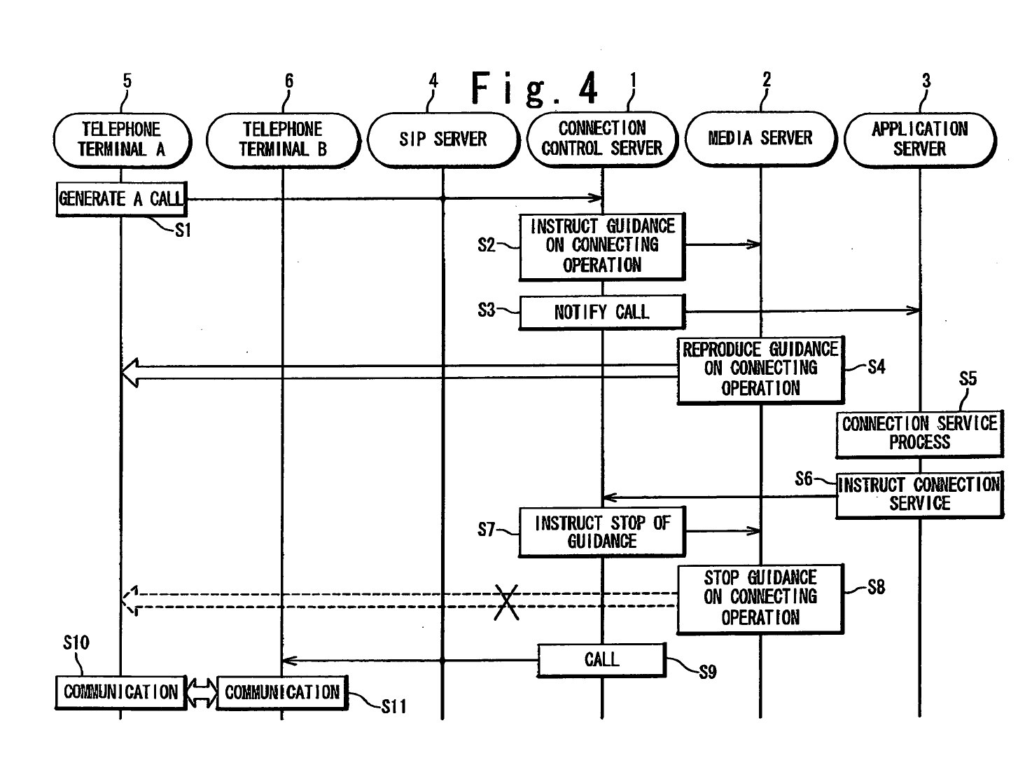

A communication system according to the first exemplary embodiment of the present invention will be described below with reference to FIGS. 1 to 4. FIGS. 1 and 2 are block diagrams showing the configuration the communication system and a connection control server in this exemplary embodiment, respectively, and FIGS. 3 and 4 are diagrams showing the operations.

### (Configuration)

In the communication system in this exemplary embodiment, as shown in FIG. 1, communication terminals such as a telephone terminal 5 of a user A and a telephone terminal 6 of a user B are connected to a network N such as an IP network. It should be noted that other communication terminals of various users are also connected to the network N.

Also, on the network N, an SIP server 4 is provided for carrying out the connection control including a call control and a session establishment for the communication terminals such as the IP telephones or a different telephone in accordance with the SIP protocol. Moreover, on the network N, a connection control system 10 is provided and includes a connection control server 1 for carrying out the connection control of the communication terminal such as the IP telephones; a media server 2 for providing contents of sound and video to the communication terminals; and an application server 3 for setting a connection control data to the communication terminals and issuing a connection control instruction to the connection control server 1. The configurations of the respective servers will be described below in detail.

### <Telephone Terminal>

The respective telephone terminals 5 and 6 (communication terminals) are the IP telephone terminals used by the users A and B, respectively, and can be connected to the different telephone terminals and equipments on the basis of the call control and connection control That are performed by the SIP server 4 provided on the network N. For example, a telephone terminal generates a call for a different telephone terminal to and receives a call generated by a different telephone terminal from the SIP server 4. If the telephone terminal called responds to the call, a session is established between the telephone terminals to allow a communication. Since the communication terminal is connected to a different terminal such as the media server 2, and a conference server (not shown) by the connection control server 1 or the SIP server 4, provision of various types of service such as listening to music, viewing a video picture, and communication among many persons.

### <SIP Server>

The SIP server 4 is a server computer for carrying out the call control and connection control between the IP telephones, the cell phones, and the like in accordance with the SIP protocol. The SIP server 4 transmits predetermined message to the respective telephone terminals 5 and 6 and carries out the call control and the connection control in response to an instruction from the connection control server 1, which will be described later. Specifically, the SIP server 4 performs the calling for the telephone terminals 5 and 6, the session establishment, and the like. Here, a gateway (not shown) is provided between the SIP server 4 and the telephone terminals 5 and 6. Thus, in the gateway, signals from the telephone terminals 5 and 6 or signals to the telephone terminals 5 and 6 are converted, to allow the communication between the telephone terminals 5 and 6 and the SIP server 4. Thus, the foregoing call control is attained.

### <Connection Control Server>

The connection control server 1 (information processing apparatus) is a typical server computer, which includes an operation unit such as CPU, and a storage unit such as a hard disc drive. Since a predetermined program is executed by the operation unit, as shown in FIG. 2, a call receiving section 11, a content providing section 12 and a connection control section 13 are built up The call receiving section 11 receives a call from the telephone terminal 5 through the SIP server 4 and notifies it to the content providing section 12 and the connection control section 13. At this time, the call receiving section 11 notifies the information included in the call, in short, a call transmitter number, a call receiver number, an assigned session ID and the like.

The content providing section 12, when receiving the notice [[report]] of the call, notifies the media server 2 of the transmitter number and instructs the media server 2 to provide the content data, stored in the media server 2. The content data may be pre-specified by the telephone terminal 5 of the user A generating the call or the content providing section may determine it. In short, the content providing section 12 operates immediately after the generation of the call to carry out the control so that the content data is provided from the media server 2 to the telephone terminal 5 of the user A immediately after the generation of the call, which will be described later. Here, the content data that is provided to the telephone terminal 5 from the media server 2 in accordance with the content provision instruction is, for example, a voice guidance data to notify the connection state, a voiced/acoustic data representing a prescribed advertisement message, and a melody data of a predetermined music piece. However, the content data is not limited to the above sound information, and this may be picture information or the picture information including the sound information. Also, the content providing section 12 controls the media server 2 to provide the content data for the telephone terminal 5, until the connection control section 13 completes the connection control for the telephone terminal 5, which will be described later. Thus, when receiving the connection control instruction from the application server 3, the connection control section 13, instructs the media server 2 to stop the reproduction of the content data in response to this reception. The operation will be described later.

The connection control section 13 when receiving the notice of the call from the call receiving section 11 as mentioned above, firstly notifies the information included in the call, namely, the transmitter number, the receiver number and the like, to the application server 3 and generates a call notice. The connection control section 13 receives the connection control instruction from the application server 3, which indicates the connection control data set by the application server 3 for this call. The connection control section 13 actually performs the connection control for the telephone terminal 5 on the transmitting side and the telephone terminal 6 on the receiving side in accordance with the instruction. The connection control section 13 performs the connection control such as the calling to a different telephone terminal (receiving terminal), the session establishment, the call rejection, and the transferring of the call, and further, the designation of a different sever which has a function to provide the guidance data to establish a session between the telephone terminal and the sever.

### <Application Server>

The application server 3 will be described below. The application server 3 is a server computer for setting the connection control data for the telephone terminals and issuing the connection control instruction to the connection control server 1. One or more applications are installed or loaded to set the connection control data. Specifically, the application server 3 receives the call from the telephone terminal 5 through the SIP server 4 and the connection control server 1. At that time, the application server 3 refers to the information such as the transmitter number, the receiver number, and the session ID, which are included in the call, and performs a process for setting the connection control data for the call. It should be noted that the setting of this connection control data is different depending on the application being executed. The processes to provide a wide variety of communication services are performed such as a process to select a melody prepared in correspondence to the transmitter or the receiver and to provide a ring back melody while the telephone terminal 6 on the receiving side is under the call; a process to transfer a call from the telephone terminal 6 on the receiving side to a different telephone terminal; and a process to carry out a three-party communication. The application server 3 instructs the connection control data being set to the connection control server 1. It should be noted that in this embodiment, a case of calling the telephone terminal 6 on the receiving side is merely explained.

### <Media Server>

The media server 2 will be described below. The media server 2 is a server computer for providing the foregoing content data such as a sound data, a video data to the telephone terminals 5 and 6. Specifically, the media server 2 stores a pre-prepared voice guidance data, advertisement data and melody data. In response to a content provision instruction from the content providing section 12 in the connection control server 1, the media server 2 establishes a session with the telephone terminal 5 which has issued the call and then provides any of the content data. When an instruction is given to stop the provision of the content data, the media server 2 stops providing the content data.

### (Operation)

The operation in the above-mentioned configuration will be described below with reference to FIGS. 3 and 4. FIG. 3 is a diagram showing a flow of the data in the entire system. FIG. 4 is a sequence diagram showing the operation[s] of the entire system.

At first, by using the telephone terminal 5 the user A generates a call to the user B of the telephone terminal 6. A call generation is notified through the SIP server 4 to the connection control server 1 (as shown by an arrow (1) in FIG. 3, at a step S1 of FIG. 4. The connection control server 1 notifies the sender telephone number and the like, which are contained in the call, to the media server 2 and instructs the media server 2 to provide the voice guidance data to indicate a connection operation, to the calling telephone terminal 5 (as shown by an arrow (2) of FIG. 3, at a step S2 of FIG. 4). It should be noted that this instruction is generated immediately after the connection control server 1 receives the call. Also, before or after this or at the substantially same time, the connection control server 1 sends a notice to the application server 3 to notify the transmitter telephone number, the receiver telephone number and the like, which are included in the call, to the application server 3 (as shown by the arrow (2) of FIG. 3, at a step S3 of FIG. 4). At this time, the notice is also made to the applications, predetermined by the user A on the transmitting side and the user B on the receiving side, to execute the connection control process.

Subsequently, receiving the provision instruction of the content data from the connection control server 1 at the step S2, the media server 2 establishes a session to the telephone terminal 5 of the user A having generated the call and sends the voice guidance data indicating the connection operation, which is one of the content data (as shown by an arrow (3) of FIG. 3, at a step S4 of FIG. 4). Thus, the voice guidance data is provided for the telephone terminal 5 of the user A immediately after the generation of the call. Therefore, the user A can listen to the voice guidance immediately after the generation of the call and can avoid a state of silence, an unnecessary connection tone and the like.

While the user A listens to the voice guidance, the process for setting the connection control data corresponding to the call is performed by the application server 3 in response to the call notice at the step S3 (Step S5 of FIG. 4). The application server 3 sets the connection control data and then issues the connection control instruction to the connection control server 1 (as shown by an arrow (4) of FIG. 3, at a step S6 of FIG. 4).

Receiving the control instruction, the connection control server 1 performs the connection control between the telephone terminals in response to the instruction. Here, it is supposed that the telephone terminal 6 of the user B is called through the SIP server 4 (as shown by an arrow (5) of FIG. 3, at a step S9 of FIG. 4). Then, while the telephone terminal 6 is called by the connection control server 1 on the receiving side, a ring back tone is provided for the telephone terminal 5 on the transmitting side. Thus, prior to the calling of the telephone terminal 6, the connection control server 1 instructs the media server 2 to terminate the transmission of the voice guidance provided for the telephone terminal 5 (Step S7 of FIG. 4). In response to this instruction, the transmission of the voice guidance from the media server 2 is ended (Step S8 of FIG. 4). In short, until the execution of the process to call the receiver telephone, the content data such as the voice guidance is provided for the telephone terminal 5.

After that, when the user B answers the call from the connection control server 1 with the telephone terminal 6 (Step S9 of FIG. 4), the session between the telephone terminals 5 and 6 of the users A and B is established, to allow a communication (as shown by an arrow (6) of FIG. 3, at steps S10, S11 of FIG. 4).

As mentioned above, in the first exemplary embodiment, the predetermined contents such as the voice guidance, and the advertisement data, which indicate the connection operation, are firstly sent from the media server 2 to the telephone terminal 5 having generated the call, immediately after the generation of the call. Thus, the user A, while viewing and listening to the contents, waits for the end of the process to be executed by the application server 3 which sets the connection control data corresponding to the call. After the connection control data are set, the connection control process is started such as the calling of the telephone terminal 6 on the receiving side. For example, supposing that the telephone terminal 6 on the receiving side is located at the remote site such as overseas, it takes a time period of several seconds to carry out the connection control even if a simple call is generated from the telephone terminal 5. Thus, the user A which has generated the call can listen to the foregoing contents meanwhile. As a result, the calling user A can effectively use the wait time instead of suffering from the silent state so that the mental burden caused by the wait time can be reduced. At the same time, while the content data is provided to the communication terminals, the process to set the connection control data is performed, to allow the improvement of the quality of the communication services provided. Here, in the foregoing description, a case is exemplified where the connection control system 10 is composed of the 3 server computers of the connection control server 1, the media server 2 and the application server 3. However, the present invention is not limited thereto. The connection control system 10 may include some more computers so that the processes are further distributed, or this may be provided with a single server computer to substitute for the 3 server computers.

### Second Exemplary Embodiment

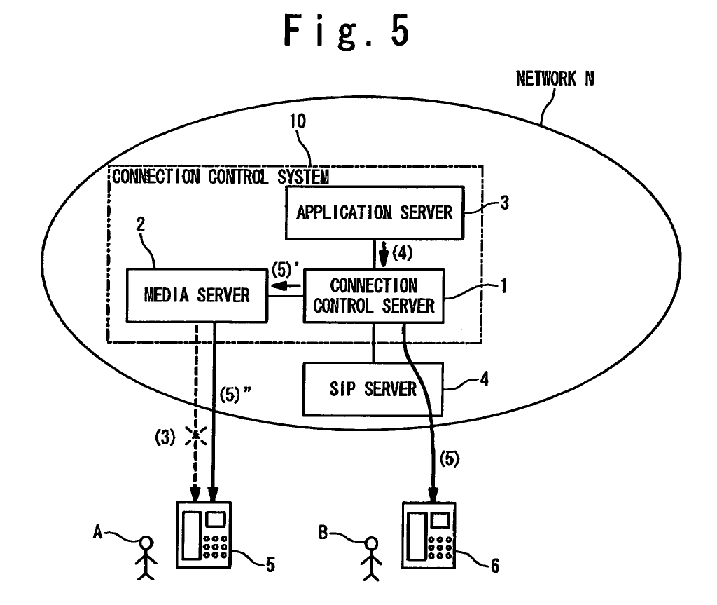

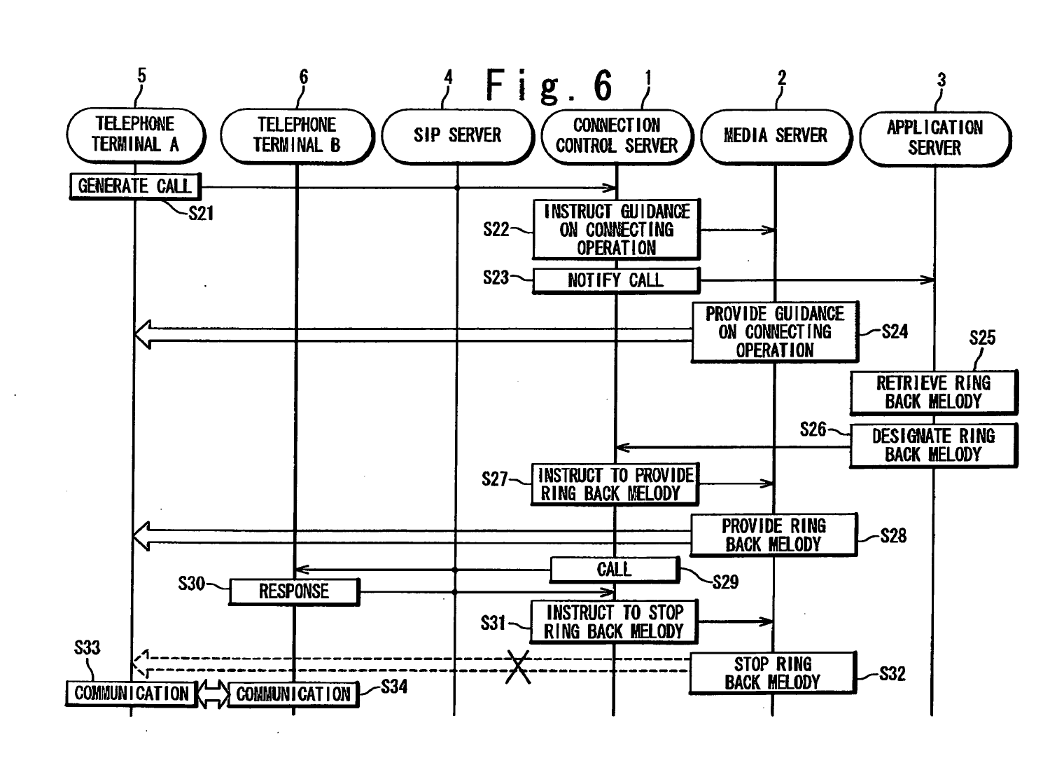

The second exemplary embodiment of the present invention will be described below with reference to FIGS. 5 and 6. FIGS. 5 and 6 are diagrams showing the operation[s] of the system in this exemplary embodiment. This exemplary embodiment basically has the configuration similar to that of the system in the first exemplary embodiment. However, in particular, a case will be described where the receiving side user B specifies a service to provide a particular melody to the calling user A while the receiving side user B is called.

### (Configuration)

At first, the melody (ring back melody) to be reproduced instead of the ring back tone during the calling operation is specified for each user and stored in the application server 3. The application server 3, when receiving the call notice from the connection control server 1, performs the process to set the connection control data. However, what kind of the connection control process is set to be executed is retrieved by using the telephone number of the telephone terminal 6 on the receiving side as a key. As for the user B, an instruction is specified to send a ring back melody to the telephone terminal having generated the call. Therefore, a process to ascertain the specified melody is performed and the connection control data are set. After that, during the connection control process, the application server 3 issues a connection control instruction to the connection control server 1 to send the specified melody to the calling telephone terminal.

Also, the connection control server 1 instructs the media server 2 to reproduce the particular ring back melody in response to the connection control instruction from the application server 3 as mentioned above.

Also, in response to the instruction from the connection control server 1 to provide the particular ring back melody, the media server 2 stops reproduction of the voice guidance, the advertisement data and the like, which are the content data already sent to the telephone terminal 5 as mentioned in the first exemplary embodiment, and reproduces the ring back melody for the telephone terminal 5 as instructed.

### (Operation)

The operation[s] in the foregoing configuration will be described below with reference to FIGS. 5 and 6. FIG. 5 is a diagram showing a flow of the data in the entire system. FIG. 6 is a sequence diagram showing the operation in the entire system. It should be noted that the basic operation will be described by referring to FIG. 3.

At first, through the telephone terminal 5, the user A generates a call to the user B of the telephone terminal 6. This call is transferred through the SIP server 4 to the connection control server 1 (as shown by the arrow (1) of FIG. 3, at a step S21 of FIG. 6). Then, the connection control server 1 notifies the transmitter terminal number and the like, which are contained in the call, to the media server 2 and instructs the media server 2 to provide the voice guidance data, which indicates the connection operation, to the calling telephone terminal 5 (as shown by the arrow (2) of FIG. 3, at a step S22 of FIG. 6). Also, before or after this step, or at the substantially same time, the connection control server 1 sends a notice to the application server 3 to notify the transmitter terminal number and the receiver terminal number and the like, which are included in the call request, to the application server 3 (as shown by an arrow (2)′ of FIG. 3, at a step S23 of FIG. 6).

Then, the media server 2, which receives the provision instruction of the content data from the connection control server 1 at the step S22, establishes the session with the telephone terminal 5 of the user A having generated the call and sends the voice guidance data (as shown by the arrow (3) of FIG. 3, at a step S24 of FIG. 6). Thus, the voice guidance data that is one of the content data is provided for the telephone terminal 5 of the user A immediately after the generation of the call.

Then, while the user A listens to the voice guidance, the process to set the connection control data corresponding to the call is executed by the application server 3 in response to the notice of the generation of the call at the step S23 (Step S25 of FIG. 6). In this exemplary embodiment, a process to retrieve the melody specified by the receiving side user B is performed. Then, the application server 3 designates the ring back melody according to the result of the above process and provides the connection control instruction for the connection control server 1 (as shown by the arrow (4) of FIG. 5, at a step S26 of FIG. 6).

Receiving the connection control instruction, the connection control server 1 performs the connection control between the communication terminals in response to the connection control instruction [[)]]. In the second exemplary embodiment, the user B of the telephone terminal 6 is called through the SIP server 4 (as shown by the arrow (5) of FIG. 5, at a step S29 of FIG. 6). Then, the connection control server 1 instructs the media server 2 to send the designated ring back melody to the calling telephone terminal 5 (as shown by the arrow (5)′ of FIG. 5, at a step S27 of FIG. 6). Then, the media server 2 terminates to reproduce the voice guidance, which starts to be sent at the step S24, and provides the designated ring back melody for the telephone terminal 5 (as shown by the dotted arrow (3), and an arrow (5)″ of FIG. 5, at a step S28 of FIG. 6).

After that, when the user B responds to the call for the telephone terminal 6 (Steps S29, S30 of FIG. 6), the connection control server 1 detects this response and instructs to stop provision of the ring back melody from the media server 2 to the telephone terminal 5 (Step S31 of FIG. 6). In response to this instruction, the transmission of the ring back melody from the media server 2 ends (Step S32 of FIG. 6). Then, the session is established between the telephone terminals 5 and 6 of the users A and B, to allow the communication (as shown by the arrow (6) of FIG. 3, at steps S33, S34 of FIG. 6).

Even if the [a] ring back melody is specified, the silent state is brought about until the ring back melody is provided. Namely, the calling user A has to wait during the period from the generation of the call to the designation of the ring back melody [[to be played]]. However, in this wait time, the content data such as the foregoing voice guidance is reproduced, which can suppress the mental burden on the user A. Thus, after the calling starts actually, the ring back melody reproduction is performed, which can enrich the communication services.

### Third Exemplary Embodiment

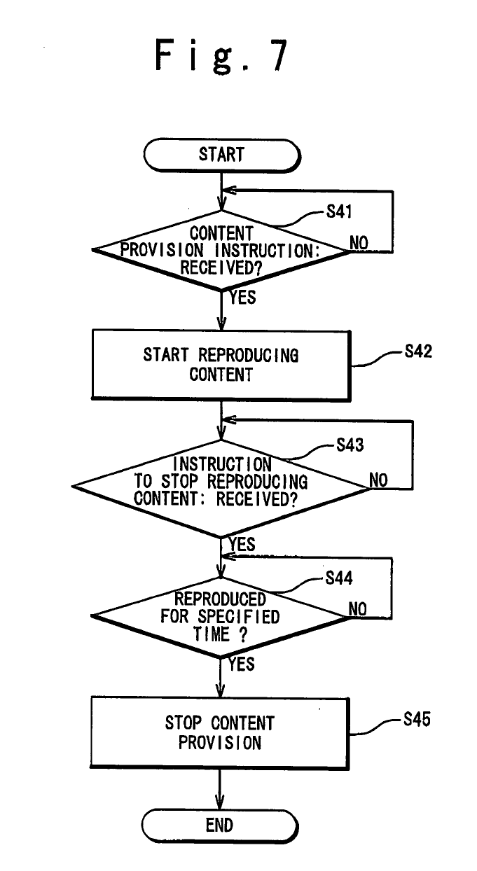

The third exemplary embodiment of the present invention will be described below with reference to FIG. 7. FIG. 7 is a flowchart showing the operation of the media server. This embodiment especially has a feature that the user can view and listen to the preferably divided parts of the content data to be reproduced immediately after the generation of the call.

### (Configuration)

At first, when instructing the media server 2 to provide the content data, the content providing section 12 of the connection control server 1 in this exemplary embodiment has the function of instructing the media server 2 not to stop the reproduction of the content data during a time period specified in advance for each content data. As for the time period specified for each content data, for example, a time can be specified adequately for a meaningful block of the content data to be reproduced, so that the user views and listens to the whole block and comprehends the contents, when the content data is the voice guidance data, the advertisement data and the like. Also, when the content data is the melody or the like, a time period can be specified adequately for a preferably divided part of the music.

The media server 2 reproduces the content data at least for the time period specified. In short, the media server 2 has a function of continuing the reproduction of the content data even if the stop of the content reproduction is instructed by the connection control server 1 prior to the elapse of the specified time period, and ending the reproduction after the elapse of the time specified.

### (Operation)

The operation of the media server 2 in the foregoing configuration will be described below with reference to FIG. 7. At first, as mentioned above, the connection control server 1, when receiving the call from the telephone terminal 5 of the user A, provides the content provision instruction and an instruction of a minimum reproduction time. The media server 2 receiving these instructions (Yes at Step S41) starts reproducing the content data for the telephone terminal 5 (Step S42).

After that, as described in the first and second exemplary embodiments, the application server 3 sets the connection control data. Then, when the connection control server 1 performs the connection control, the stop of the content reproduction is instructed. However, receiving this instruction, the media server 2 (Yes at Step S43) continues the reproduction unless the media server 2 reproduces the content data for the specified time period (No at Step S44). Then, after the reproduction is performed for the specified time, the media server 2 stops to reproduce the content data (Step S45).

After that, as described in the second exemplary embodiment, when the reproduction of the ring back melody is instructed, the designated melody different from the foregoing content data is provided for the telephone terminal 5.

Consequently, the calling user can view and listen to the content data until the end of the preferably divided part thereof. Thus, the effect resulting from the provision of the content data may be increased. In particular, when the content data is the advertisement data, this is further effective.

It should be noted that the content data in which a block is defined in advance as part of the data reproduced for the minimum time period, has been accumulated in the media server 2. This block is thoroughly reproduced in accordance with the reproduction instruction from the connection control server 1. Thus, the media server 2 can make the user listen to the whole block of the content data, as mentioned above.

### Fourth Exemplary Embodiment

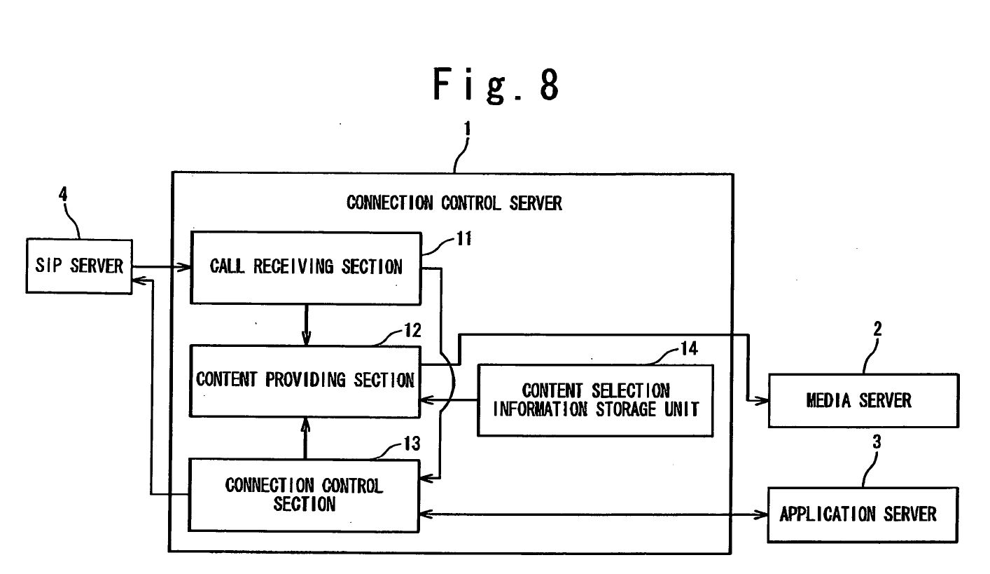

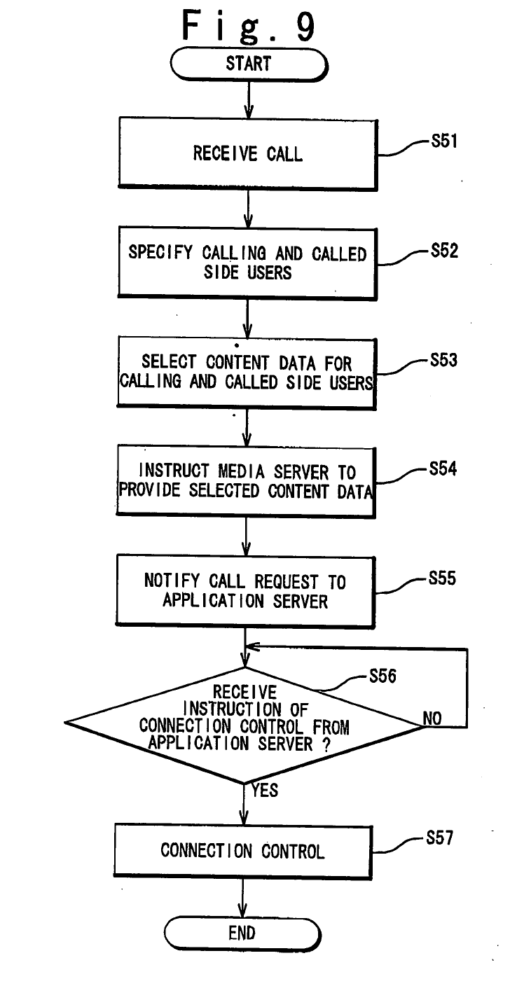

The fourth exemplary embodiment of the present invention will be described below with reference to FIGS. 8 and 9. FIG. 8 is a block diagram showing the configuration of the connection control server 1, and FIG. 9 is a flowchart showing the operation of the connection control server 1.

### (Configuration)

The connection control server 1 in this exemplary embodiment contains a content selection information storage unit 14 that stores information to select the content data for each user. In short, the information is recorded for every user to specify what kind of the content data is provided for the telephone terminal on the calling side when the user generates a call or when the user is called. For example, when there is an advertisement data, the information about the advertisement data as the content data is recorded, so that the particular advertisement data is provided for the telephone terminal on the calling side when the user is called.

The content providing section 12 of the connection control server 1 in this exemplary embodiment, when receiving the call, ascertains the telephone terminal on the transmitting side that generates the call or the telephone terminal on the receiving side. After that, the content providing section 12 refers to the content selection information storage device 14, ascertains the content data recorded for any of the concerning telephone terminals and then instructs the media server 2 to provide the ascertained content data. At this time, the content providing section 12, for example, designates the content data for the telephone terminal on the receiving side giving precedence to the receiving side.

### (Operation)

The operation of the connection control server 1 in the foregoing configuration will be described below with reference to FIG. 9. At first, when the call is received from the telephone terminal 5 of the user A through the SIP server 4 (Step S51), the transmitting side user A and the receiving side user B are recognized from the transmission and reception numbers included in the call (Step S52). Then, it is examined by retrieving the content selection information storage device 14 whether or not the content data is specified in advance for each of the recognized users A and B, and the content data specified for any one of them is selected (Step S53). At this time, if the content data is specified for both of the users, the precedence can be given to any one of them and the selection may be made (for example, the precedence is given to the receiving side user).

Subsequently, the connection control server 1 instructs the media server 2 to provide the selected content data to the telephone terminal 5 of the calling user A (Step S54). At the same time, the connection control server 1 issues the call notice to the application server 3 so that the connection control data are set (Step S55). Then, the media server 2 receiving the instruction at the step S54 provides the selected content data for the calling telephone terminal 5.

After that, similarly to the above-mentioned exemplary embodiments, if there is the connection control instruction from the application server 3 (Yes at Step 556), the connection control is performed in response to this instruction (Step S57).

Consequently, the content data provided for the telephone terminal immediately after dialing can be specified by the calling user itself or by the receiving side user to be called. Thus, the content data can be provided based on the user's taste, thereby improving the convenience and favor of the user.

The present invention can be used by the Internet service provider and by the communication carrier to offer the various communication services to the users who carry out telephone calls and the like. Thus, there is an industrial usability.

Although the inventions has been described above in connection with several exemplary embodiments thereof, it will be apparent to those skilled in the art that those exemplary embodiments are provided solely for illustrating the invention, and should not be relied upon to construe the appended claims in a limiting sense.

What is claimed is:

1. A method of performing a connection control on communication terminals through a network, comprising:
receiving a call from a calling communication terminal;
notifying said call to an application server which sets a connection control data based on a content of said call;
performing said connection control between said communication terminals in response to an instruction from the application server after said notice; and
controlling a content server to provide a content data for said calling communication terminal before said connection control is completed.

2. The method according to claim 1, wherein said controlling comprises:
controlling said content server to provide said content data for said calling communication terminal in response to the reception of said call.

3. The method according to claim 2, wherein said controlling comprises:
controlling said content server to provide said content data for said calling communication terminal until completion of said connection control.

4. The method according to claim 2, wherein said controlling comprises:
controlling said content server to continue to provide said content data for said calling communication terminal until a predetermined time passes.

5. The method according to claim 1, wherein said controlling further comprises:
ascertaining said calling communication terminal; and
determining said content data based on said ascertained calling communication terminal.

6. The method according to claim 1, wherein said controlling comprises:
ascertaining a called one of said communication terminals; and
determining said content data based on said ascertained called communication terminal.

7. An information processing apparatus for performing a connection control between communication terminals through a network, comprising:
receiving means for receiving a call from a calling communication terminal;
notifying means for notifying reception of said call to an application server which sets a connection control data;
control means for controlling a content server to provide a content data for said calling communication terminal before a connection control between said communication terminals is completed; and
connecting means for performing said connection control in response to an instruction from said application server.

8. The information processing apparatus according to claim 7, wherein said control means controls said content server to provide said content data for said calling communication terminal in response to the reception of said call.

9. The information processing apparatus according to claim 8, wherein said control means controls said content server to provide said content data for said calling communication terminal until completion of said connection control.

10. The information processing apparatus according to claim 8, wherein said control means controls said content server to continue to provide said content data for said calling communication terminal until a predetermined time passes.

11. The information processing apparatus according to claim 7, further comprises:
ascertaining said calling communication terminal, and
wherein said control means determines said content data based on said ascertained calling communication terminal.

12. The information processing apparatus according to claim 7, further comprising:
ascertaining a called one of said [the] communication terminals, and
wherein said control means determines said content data based on said ascertained called communication terminal.

13. A computer-readable software product for realizing a method of performing a connection control on communication terminals through a network, said method comprising:
receiving a call from a calling one of communication terminals;
notifying the reception of said call to an application server such that a connection control data is set;
controlling a content server to provide a content data for said calling communication terminal before said connection control is completed; and
performing said connection control between said communication terminals in response to an instruction from said application server after said notice.

14. The computer-readable software product according to claim 13 wherein said controlling comprises:
controlling said content server to provide said content data for said calling communication terminal in response to the reception of said call.

15. The computer-readable software product according to claim 14 wherein said controlling comprises:
controlling said content server to provide said content data for said calling communication terminal until completion of said connection control.

16. The computer-readable software product according to claim 14, wherein said controlling comprises:
controlling said content server to continue to provide said content data for said calling communication terminal until a predetermined time passes.

17. The computer-readable software product according to claim 13, wherein said controlling further comprises:
ascertaining said calling communication terminal; and
determining said content data based on said ascertained calling communication terminal.

18. The computer-readable software product according to claim 13, wherein said controlling comprises:
ascertaining a called one of said communication terminals; and
determining said content data based on said ascertained called communication terminal.
